(19) United States
(12) Patent Application Publication
(10) Pub. No.: US 2025/0123812 A1
(43) Pub. Date: Apr. 17, 2025

(54) CODE COMPLETION METHOD BASED ON BIG MODEL, APPARATUS AND ELECTRONIC DEVICE

(71) Applicant: BEIJING BAIDU NETCOM SCIENCE TECHNOLOGY CO., LTD., Beijing (CN)

(72) Inventors: Yuehao Zhao, Beijing (CN); Wenjie Li, Beijing (CN); Chuqing Wang, Beijing (CN); Yunpeng Peng, Beijing (CN); Sai Gao, Beijing (CN); Hui Li, Beijing (CN); Junwei Xing, Beijing (CN); Wanpeng Niu, Beijing (CN); Bingfei Zhang, Beijing (CN)

(73) Assignee: BEIJING BAIDU NETCOM SCIENCE TECHNOLOGY CO., LTD., Beijing (CN)

(21) Appl. No.: 18/988,135

(22) Filed: Dec. 19, 2024

(30) Foreign Application Priority Data
Sep. 12, 2024 (CN) 202411281803.9

(51) Int. Cl. G06F 8/30; G06F 8/41

(52) U.S. Cl. CPC G06F 8/30; G06F 8/433

(57) ABSTRACT

The disclosure provides a code completion method based on a big model. The method includes: determining a first code element where a position to be completed is located in a first code file to be completed; determining a second code file having a dependency relationship with the first code file from a development project to which the first code file belongs; determining, according to the first code element, a second code element whose correlation with the first code element meets a preset condition, in which the second code element belongs to at least one of the first code file or the second code file; and generating a target code corresponding to the position to be completed through a big model based on a signature of the second code element.

### CROSS-REFERENCE TO RELATED APPLICATION

The present application claims priority to and benefits of Chinese Patent Application Serial No. 2024112818039, filed on Sep. 12, 2024, the entire content of which is incorporated herein by reference.

### TECHNICAL FIELD

The disclosure relates to artificial intelligence (AI) technical fields such as big model, deep learning and natural language processing, and also relates to internet technical fields such as code recommendation, code generation and software development. The disclosure can be applied to AI-based interactive scenes, for example, to application scenes such as generative search, intelligent assistant, and code recommendation. It especially relates to a code completion method based on a big model, a code completion apparatus based on a big model and an electronic device.

### BACKGROUND

A big model can handle a variety of tasks, such as code completion, knowledge answering, natural language to structured query language (NL2SQL), and information extraction. Taking code completion as an example, a context code of the position where the cursor is in a code file currently being edited by a user may be input into the big model, and the big model may output a recommendation code for the position where the cursor is in response to such information.

### SUMMARY

According to a first aspect of the disclosure, a code completion method based on a big model is provided. The method includes: determining a first code element where a position to be completed is located in a first code file to be completed; determining a second code file having a dependency relationship with the first code file from a development project to which the first code file belongs; determining, according to the first code element, a second code element whose correlation with the first code element meets a preset condition, in which the second code element belongs to at least one of the first code file or the second code file; and generating a target code corresponding to the position to be completed through a big model based on a signature of the second code element.

According to a second aspect of the disclosure, an electronic device is provided. The electronic device includes:
at least one processor; and
a memory communicatively connected to the at least one processor;
in which the memory stores instructions executable by the at least one processor, and the instructions are executed by the at least one processor to cause the at least one processor to perform the method described in the first aspect.

According to a third aspect of the disclosure, a non-transitory computer-readable storage medium having computer instructions stored thereon is provided. The computer instructions are used to cause a computer to perform the method described in the first aspect.

### BRIEF DESCRIPTION OF THE DRAWINGS

The accompanying drawings are used to better understand this solution and do not constitute a limitation to the disclosure, in which:

FIG. 1 is a flowchart of a code completion method based on a big model according to an embodiment of the disclosure.

FIG. 2 is a flowchart of a code completion method based on a big model according to another embodiment of the disclosure.

FIG. 3 is a schematic diagram of a code dependency graph according to an embodiment of the disclosure.

FIG. 4 is a flowchart of a code completion method based on a big model according to yet another embodiment of the disclosure.

FIG. 5 is a schematic diagram of a code completion apparatus based on a big model according to an embodiment of the disclosure.

FIG. 6 is a block diagram of an electronic device configured to implement the code completion method based on the big model of embodiments of the disclosure.

### DETAILED DESCRIPTION

The following description of exemplary embodiments of the disclosure is provided in combination with the accompanying drawings, which includes various details of embodiments of the disclosure to aid in understanding, and should be considered merely exemplary. Those skilled in the art understood that various changes and modifications of the embodiments described herein can be made without departing from the scope and spirit of the disclosure. For the sake of clarity and brevity, descriptions of well-known functions and structures are omitted from the following description.

In the technical solutions of this disclosure, the collection, storage, usage, processing, transmission, provision and disclosure of private information of users are all carried out with the consent of the users, and are comply with the provisions of relevant laws and regulations, and do not violate public order and good customs.

In code completion methods of the related art, the context code of the position where the cursor is in the code file currently being edited by the user is inputted into a big model, and the big model outputs recommendation codes for the position where the cursor is based on such information, in which the information input into the big model is only the information in the current code file. When the code to be completed of the position where the cursor is needs cross-file information, for example, when the code to be completed, of the position where the cursor is, is a part of code in a certain class and the class needs to call methods of other classes, the big model is prone to hallucination, and thus the accuracy of the recommendation code generated by the big model is poor. In related arts, how to improve the accuracy of the recommendation code generated by the big model during performing the code completion by the big model is a problem to be solved.

In order to improve the accuracy of code completion, embodiments of the disclosure provide a code completion method based on a big model, a code completion apparatus based on a big model and an electronic device.

A code completion method based on a big model, a code completion apparatus based on a big model and an electronic device of the embodiments of the disclosure are described below with reference to the attached drawings.

It should be noted that an execution subject of the code completion method based on the big model in this embodiment is the code completion apparatus based on the big model. The code completion apparatus based on the big model can be implemented by software and/or hardware, and can also be configured in the electronic device. The electronic device includes, but is not limited to, a terminal and a server.

FIG. 1 is a flowchart of a code completion method based on a big model provided by an embodiment of the disclosure.

As illustrated in FIG. 1, the code completion method based on the big model includes the following steps.

At step 101, a first code element, where a position to be completed is located, in a first code file to be completed is determined.

The first code file may be a code file, opened in an Integrated Development Environment (IDE) workspace, in which a part of codes is to be completed, or other code files in which a part of codes is to be completed, which is not limited in the disclosure. The IDE workspace refers to a logical container used to organize and manage project files and resources in the IDE. The workspace usually includes one or more development projects, each of which contains a series of code files, directories and other resources needed in the development process.

The position to be completed may be a position of the cursor in the first code file or a position specified by the user in the first code file, which is not limited in the disclosure.

A code element is a basic component unit of a software program. The code element includes a class, a class method, an interface, a field, an inner class, a configuration file, etc.

The first code element where the position to be completed is located is a code element containing the position to be completed. For example, the position to be completed is the position of the cursor in the first code file, and the first code element where the position to be completed is located is a code element that can be accessed by the cursor. It should be noted that the number of the first code element where the position to be completed is located may be one or at least two.

For example, in the case where the position to be completed is the position of the cursor in the first code file, a class is defined in the first code file, and a method including a code segment is defined in this class, and the cursor is located at a certain position in the code segment. Therefore, the first code element where the position to be completed may include the method and the class.

At step 102, a second code file having a dependency relationship with the first code file is determined from a development project to which the first code file belongs.

The development project is a complete software application or a set of related software components. For example, the development project may be implemented by an independent application, a website, a framework, a plug-in or other forms of software. Under a development project, different code files may have a dependency relationship.

The dependency relationship between code files refers to that one code file needs resources provided by another code file to work normally. For example, one code file needs the class or the method provided by another code file to work normally. This dependence relationship may be direct or indirect.

For example, a code file 1 uses a class or function in a code file 2 by importing a sentence, and the code file 2 uses a method provided by a code file 3 by importing a sentence, and thus the code file 2 and the code file 3 both have a dependency relationship with the code file 1. The code file 1 and the code file 2 have a direct dependency relationship, and the code file 1 and the code file 3 have an indirect dependency relationship.

There may be one second code file or at least two second code files that has/have a dependency relationship with the first code file.

At step 103, according to the first code element, a second code element whose correlation with the first code element meets a preset condition is determined, in which the second code element belongs to at least one of the first code file or the second code file.

It is understood that the first code file or each second code file includes at least one code element. In an example embodiment, by querying the code elements in the first code file and the second code file according to the first code element, the second code element whose correlation with the first code element meets the preset condition is determined.

There may be one second code element or at least two second code elements. Each of the second code element may belong to the first code file, or the second code file, or both the first code file and the second code file.

The correlation between the second code element and the first code element refers to a degree of correlation between the second code element and the first code element. The criteria for judging the correlation between the second code element and the first code element can be set as required. For example, in a case where the similarity between a packet name of a packet where the second code element is located and a packet name of a packet where the first code element is located is high, it is determined that the correlation between the second code element and the first code element is high.

The correlation between the second code element and the first code element meets the set condition, which can be set as required, for example, the correlation between the second code element and the first code element exceeds a correlation threshold. The correlation threshold can be set as required, which is not limited in the disclosure.

It should be noted that in a case where the number of the first code element is one, the correlation between the second code element and the first code element is the correlation between the second code element and this one first code element. In a case where the number of first code element is at least two, the correlation between the second code element and the first code element can be understood as the correlation between the second code element and the whole of the at least two first code elements.

At step 104, a target code corresponding to the position to be completed is generated through a big model based on a signature of the second code element.

The signature of the second code element is an identifier for uniquely identifying the second code element, and it can define the way in which the second code element is called or cited. The signature of the second code element may include a name of the second code element or a parameter list. For example, if the second code element is a class, the signature of the class may include, for example, a class name, an interface implemented by the class, or a combination of extend parent classes.

The big model is a large-scale neural network model trained by deep learning algorithms to understand and generate natural language texts. The big model can capture the complexity and nuances of language by training through a large number of text data, in order to perform various natural language processing tasks, such as text generation, question answering system, and semantic understanding and reasoning. The design purpose of this model is to improve the expressive capability and predictive performance of the model, to enable the model to deal with more complex tasks and data, and to simulate human intelligence. The big model may include a Generative Pre-Trained Transformer 3 (GPT3), a GPT4, a Text-to-Text Transfer Transformer (T5), and a Large Language Model Meta AI (LLaMA).

The target code corresponding to the position to be completed is a code configured to complete the position to be completed.

In an example embodiment, the signature of the second code element can be input into the big model, and the big model outputs the target code corresponding to the position to be completed.

According to the code completion method based on the big model provided by embodiments of the disclosure, the first code element, where the position to be completed is located, in the first code file to be completed is determined. The second code file having a dependency relationship with the first code file is determined from the development project to which the first code file belongs. According to the first code element, the second code element whose correlation with the first code element meets the preset condition is determined, in which the second code element belongs to at least one of the first code file or the second code file. The target code corresponding to the position to be completed is generated through the big model based on the signature of the second code element. Because the second code file is a code file that has a dependency relationship with the first code file under the development project to which the first code file belongs, the second code element is a code element determined from the code elements in the first code file and the second code file and belonging to at least one of the first code file or the second code file, and the correlation between the second code element and the first code element meets the preset condition. Thus, when the target code corresponding to the position to be completed is generated through the big model based on the signature of the second code element, the big model can not only consider the code element, in the first code file to be completed, whose correlation with the first code element meets the preset condition, but also can consider the code element, in the second code file having the dependency relationship with the first code file, whose correlation with the first code element meets the preset condition. Therefore, the problem of low accuracy of the target code output by the big model when the cross-file information is needed for the code completion can be avoided, and the accuracy of the code completion performed by the big model can be improved.

In order to clearly explain the process of determining the second code element whose correlation with the first code element meets the preset condition according to the first code element, the embodiments of the disclosure also provide a code completion method based on a big model.

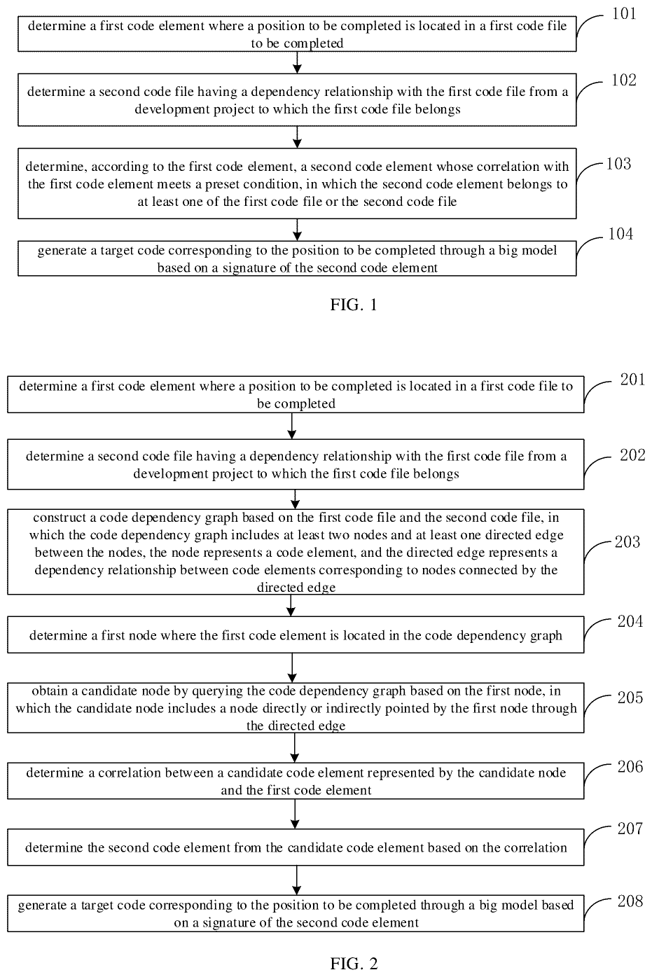

FIG. 2 is a flowchart of a code completion method based on a big model according to another embodiment of the disclosure.

As illustrated in FIG. 2, the code completion method based on the big model includes the following steps.

At step 201, a first code element, where a position to be completed is located, in a first code file to be completed is determined.

At step 202, a second code file having a dependency relationship with the first code file is determined from a development project to which the first code file belongs.

At step 203, a code dependency graph is constructed based on the first code file and the second code file, in which the code dependency graph includes at least two nodes and at least one directed edge between the nodes, the node represents a code element, and the directed edge represents a dependency relationship between code elements corresponding to nodes that are connected by the directed edge.

The code dependency graph is a graphical representation in software development, and it is used to describe the dependency relationship between code elements. Based on the first code file and the second code file, the way to construct the code dependency graph can refer to the related art, and will not be repeated here.

In a possible implementation, for a Java program, the code element includes at least one of: a class, an interface, a field, a class method, an inner class or a configuration file.

The inner class is a class included in another class.

Each node in the code dependency graph represents one of a class, an interface, a field, a class method (or referred to as method), an inner class (or innerClass) and a configuration file. The set of code elements represented by all the nodes respectively may include at least one of a class, an interface, a field, a class method, an inner class or a configuration file. For example, if the code dependency graph includes 90 nodes, in which 10 nodes represent classes respectively, 20 nodes represent interfaces respectively, 20 nodes represent fields respectively, 20 nodes represent class methods respectively, 10 nodes represent inner classes respectively, and 10 nodes represent configuration files respectively.

In a possible implementation, in the code dependency graph, the dependency relationship between the code elements includes at least one of:
an extend relationship between the classes;
an implements relationship between the class and the interface;
an include relationship between the class and the field;
an include relationship between the class and the class method;
an include relationship between the class and the inner class;
a configure relationship between the class and the configuration file;
a parmer_in relationship between the class and the class method; or
a parmer_out relationship between the class and the class method.

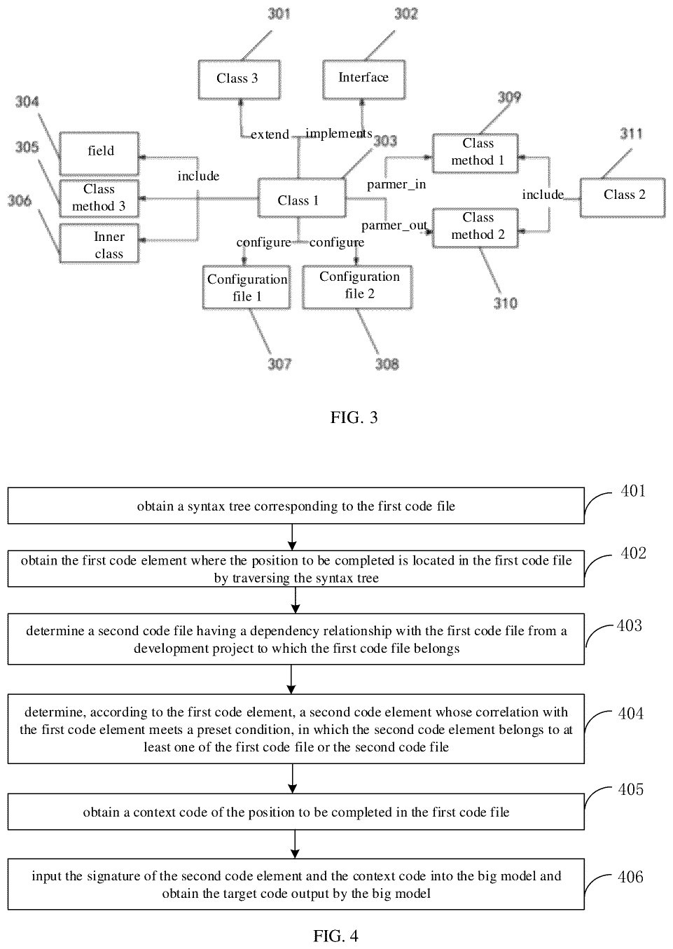

For example, FIG. 3 is a schematic diagram of part of the code dependency graph constructed based on the first code file and the second code file. Nodes 301, 303, and 311 all represent classes, and in order to distinguish different classes represented by these nodes, Class 1, Class 2, and Class 3 in FIG. 3 are used as examples. Moreover, nodes 305, 309, and 310 all represent class methods, and in order to distinguish different class methods represented by these nodes, Class method 1, Class method 2, and Class method 3 are used as examples in FIG. 3. Nodes 307 and 308 both represent configuration files, and in order to distinguish different configuration files represented by the nodes, Configuration file 1 and Configuration file 2 are used as examples in FIG. 3. Node 302 represents an interface, Node 304 represents a field, and Node 306 represents an inner class.

The directed edge between the node 301 and the node 303 represents an extend relationship between Class 1 and Class 3. The directed edge starts from the node 303 and points to the node 301, which indicates that the extend relationship between Class 1 and Class 3 is that Class 1 acquires the field and method of Class 3, that is, Class 3 is a parent class of Class 1.

The directed edge between the node 303 and the node 302 represents an implements relationship between Class 1 and the interface. The directed edge starts from the node 303 and points to the node 302, which indicates that the implements relationship between Class 1 and the interface is that Class 1 provides specific implementations of all methods declared in the interface.

The directed edge between the node 303 and the node 304 represents an include relationship between Class 1 and the field. The directed edge starts from the node 303 and points to the node 304, which indicates that the include relationship between Class 1 and the field is that Class 1 includes the field.

The directed edge between the node 303 and the node 305 represents an include relationship between Class 1 and Class method 3. The directed edge starts from the node 303 and points to the node 305, which indicates that the include relationship between Class 1 and Class method 3 is that Class 1 includes Class method 3.

The directed edge between the node 303 and the node 306 represents an include relationship between Class 1 and the inner class. The directed edge starts from the node 303 and points to the node 306, which indicates that the include relationship between Class 1 and the inner class is that Class 1 includes the inner class.

The directed edge between the node 303 and the node 307 represents a configure relationship between Class 1 and Configuration file 1. The directed edge starts from the node 303 and points to the node 307, which indicates that the configure relationship between Class 1 and Configuration file 1 is that Configuration file 1 is configured to store and manage parameters, settings and dependencies during the program is running, while Class 1 is the code structure for realizing these functions and logics. The directed edge between the node 303 and the node 308 is similar.

The directed edge between the node 311 and the node 309 represents an include relationship between Class 2 and Class method 1. The directed edge starts from the node 311 and points to the node 309, which indicates that the include relationship between Class 2 and Class method 1 is that Class 2 includes Class method 1. The directed edge between the node 311 and the node 310 is similar.

The directed edge between the node 303 and the node 309 represents a parmer_in relationship between Class 1 and Class method 1. The directed edge starts from the node 303 and points to the node 309, which indicates that the parmer_in relationship between Class 1 and Class method 1 is that a function in Class 1 receives Class method 1 as a parameter.

The directed edge between the node 303 and the node 310 represents a parmer_out relationship between Class 1 and Class method 2. The directed edge starts from the node 303 and points to the node 310, which indicates that the parmer_out relationship between Class 1 and Class method 2 is that a function in Class 1 is returned to Class method 2 as a result.

The code dependency graph is constructed based on the first code file and the second code file. Each node in the code dependency graph represents the code element. The code element includes at least one of a class, an interface, a field, a class method, an inner class or a configuration file. The directed edge between nodes represents the dependency relationship between code elements corresponding to nodes that are connected. The dependency relationship includes at least one of: an extend relationship between classes; an implements relationship between the class and the interface; an include relationship between the class and the field; an include relationship between the class and the class method; an include relationship between the class and the inner class; a configure relationship between the class and the configuration file; a parmer_in relationship between the class and the class method; or a parmer_out relationship between the class and the class method. The code dependency graph clearly shows the above dependency relationships between above code elements, which lay a foundation for accurately determining the second code element based on the code dependency graph in the future.

At step 204, a first node, where the first code element is located, in the code dependency graph is determined.

If there is only one first code element, there is one first node. If there are at least two first code elements, there are at least two first nodes.

At step 205, a candidate node is obtained by querying the code dependency graph based on the first node, in which the candidate node includes a node directly or indirectly pointed by the first node through the directed edge.

In an example embodiment, for each first node, a node directly or indirectly pointed by the first node through the directed edge may be obtained by querying the code dependency graph according to the direction of the directed edge based on the first node, and the node can be taken as the candidate node. There may be one candidate node or at least two candidate nodes. The code element represented by the candidate node can be called a candidate code element.

For a candidate node that is indirectly pointed by the first node through the directed edge, there are other nodes between the candidate node and the first node, and the directed edge starts from the first node, passes through the other nodes and then reaches the candidate node. For example, a node 1 points to a node 2 through a directed edge, the node 2 points to a node 3 through a directed edge, and the node 3 points to a node 4 through a directed edge. In this case, the node 1 points directly to the node 2 through the directed edge, and the node 1 points indirectly to the nodes 3 and 4 through the directed edges. If the node 1 is the first node, the candidate nodes include the node 2, the node 3 and the node 4.

It is understood that since the candidate node is the node directly or indirectly pointed by the first node through the directed edge, the relationship between the first node and the candidate node is that the code element represented by the first node directly or indirectly depends on the code element represented by the candidate node.

As illustrated in FIG. 3, assuming that the first node is the node 303, the candidate nodes obtained by querying the code dependency graph at least include nodes 301, 302, 304, 305, 306, 307, 308, 309 and 310.

In a possible implementation, the dependency relationship represented by the directed edge in the code dependency graph includes at least one of: an extend relationship, or an implements relationship, and the candidate node includes at least one of a second node or a third node;
in which the second node is located on a target path where the first node is located and is directly or indirectly pointed by the first node through the directed edge, and the dependency relationship represented by the directed edge on the target path is either the extend relationship or the implements relationship; and
the third node is a node directly pointed by the first node or the second node through the directed edge, and the dependency relationship represented by the directed edge between the first node or the second node and the third node is a dependency relationship other than the extend relationship and the implements relationship.

The first node may be located on one or more target paths. The dependency relationship represented by each directed edge on one target path is the extend relationship or the implements relationship. Correspondingly, the dependency relationships represented by all the directed edges on one target path may include only the extend relationship, or only the implements relationship, or both the extend relationship and the implements relationship.

In FIG. 3, assuming that the node 303 is the first node, the node 301 points to a node A (not shown in FIG. 3) through a directed edge, the dependency relationship represented by the directed edge is the extend relationship, and the node A represents a class. The node 301 also points to a node B (not shown in FIG. 3) through a directed edge, the dependency relationship represented by the directed edge is the implements relationship, and the node B represents an interface. A path formed by the directed edge between the node 303 and the node 301 and the directed edge between the node 301 and the node A is acted as a target path 1. Another path formed by the directed edge between the node 303 and the node 301 and the directed edge between the node 301 and the node B is acted as a target path 2. A path formed by the directed edge between the node 303 and the node 302 is acted as a target path 3.

The second node may include the node 301, on the target paths 1 and 2, directly pointed by the first node 303 through a directed edge, the node A, on the target path 1, indirectly pointed by the first node 303 through a directed edge, the node B, on the target path 2, indirectly pointed by the first node 303 through a directed edge, and the node 302, on the target path 3, directly pointed by the first node 303 through a directed edge.

The third node may include nodes 304, 305, 306, 307, 308, 309, and 310 directly pointed by the first node 303 through directed edges, and nodes (not shown in FIG. 3) directly pointed by nodes 301, 302, A, and B, respectively.

It should be noted that, taking the nodes 303, 301, A and B as examples, the node 303 directly points to the node 301 through the directed edge, and thus the extend relationship between nodes 303 and 301 can be called a direct extend relationship in this embodiment of the disclosure. Since the node 303 indirectly points to the node A through the directed edge, the relationship between nodes 303 and A can be called an indirect extend relationship in this embodiment of the disclosure. Since the node 303 indirectly points to the node B through the directed edge, and the relationship between nodes 303 and B can be called an indirect extend relationship or an implements relationship in this embodiment of the disclosure.

It is understood that, taking classes as an example, the extend relationship between classes is usually not limited to two classes. For example, Class 1 can extend the field and the method of Class 2, and Class 2 can extend the field and the method of Class 3. Correspondingly, the dependency relationship between Class 1 and Class 3 can be called an indirect extend relationship. Similarly, the implements relationship between class and interface is usually not limited to that between class and interface, however, other dependency relationships except the extend relationship and the implements relationship are usually limited to between two code elements.

In the embodiment of the disclosure, by querying, based on the first node, infinite directed edges in the code dependency graph, the candidate code element represented by the second node can be determined accurately. The dependency relationship between the candidate code element and the first code element is the direct extend relationship or implements relationship, or the dependency relationship between the candidate code element and the first code element is the indirect extend relationship or implements relationship. By querying a limited number of directed edges, the query range of nodes in the code dependency graph can be reduced, and the candidate code element represented by the third node can be determined quickly. The dependency relationship between the candidate code element and the first code element or between the candidate code element and the candidate code element represented by the second node is another dependency relationship except the extend relationship and the implements relationship, which lay a foundation for quickly and accurately determining the second code element from the candidate code element in the future.

At step 206, a correlation between the candidate code element represented by the candidate node and the first code element is determined.

In a possible implementation, for the candidate code element represented by any one of the candidate node, the correlation between the candidate code element and the first code element can be determined in any one of the following ways.

The correlation between the candidate code element and the first code element is determined based on at least one of:
a similarity between a packet name of a packet where the candidate code element is located and a packet name of a packet where the first code file is located; or
a distance between a first character position of the candidate code element in the first code file and a second character position of the position to be completed in the first code file;
in which in a case where the candidate code element is not in the first code file, the first character position is determined based on a character position of the first code element in the first code file.

In a possible implementation, the difference between the first character position and the second character position can be taken as the distance between the first character position and the second character position, then a ratio of the difference to the second character position can be determined. A difference between 1 and the ratio is taken as a score indicating the correlation between the candidate code element and the first code element.

The character position can be a position relative to the beginning or any other reference point in the first code file.

The second character position of the position to be completed in the first code file can be the character position of the cursor in the first code file, such as a certain character in the first code file.

For the candidate code element, in a case where the candidate code element is included in the first code file, the first character position of the candidate code element in the first code file may be a start character position of the candidate code element in the first code file. In a case where the candidate code element is not included in the first code file, the first character position of the candidate code element in the first code file can be determined based on a ratio of the character position of the first code element in the first code file to a preset value. The first code element may be a code element represented by the first node when the node corresponding to the candidate code element is queried. In a case where there is only one used first code element, a ratio of the character position of the first code element in the first code file to the preset value can be taken as the first character position of the candidate code element in the first code file. In a case where there are multiple used first code elements, a sum of ratios of character positions of all the utilized first code elements in the first code file to the preset value can be taken as the first character position of the candidate code element in the first code file. The preset value can be set as required, e.g., 2.

For example, if the first node where the position to be completed includes a node a and a node c, the node a represents a first code element 1, and the node c represents a first code element 2. The character position of the first code element 1 in the first code file is the 100^{th} character, and the character position of the first code element 2 in the first code file is the 200^{th} character, and the preset value is 2. The correlation between the candidate code element and the first code element indicates the correlation between the candidate code element and the whole of the first code elements 1 and 2.

Assuming that based on the node a, a node b can be obtained by querying the code dependency graph, and based on the node c, a node b can be also obtained by querying the code dependency graph. The node b is not included in the first code file, and the node b represents a candidate code element 3. A ratio of the character position of the first code element 1 in the first code file to the preset value of 2 and a ratio of the character position of the first code element 2 in the first code file to the preset value of 2 are summed up, and it can be obtained that the first character position of the candidate code element 3 in the first code file is the 150^{th} character.

Assuming that a node d can be obtained by querying the code dependency graph based on the node a, the node d is not included in the first code file, and the node d represents a candidate code element 4. Based on the ratio of the character position of the first code element 1 in the first code file to the preset value of 2, it can be determined that the first character position of the candidate code element 4 in the first code file is the 50^{th} character.

Assuming that the second character position of the position to be completed in the first code file is the 300^{th} character, it can be determined that the distance between the first character position of the candidate code element 3 in the first code file and the second character position of the position to be completed in the first code file is 150 (i.e. 300−150), then 1−150/300 can be taken as a score indicating the correlation between the candidate code element 3 and the whole of the first code elements 1 and 2. Furthermore, it can be determined that the distance between the first character position of the candidate code element 4 in the first code file and the second character position of the position to be completed in the first code file is 250 (i.e. 300-50), then 1−250/300 can be taken as a score indicating the correlation between the candidate code element 4 and the whole of the first code elements 1 and 2.

In a possible implementation, the similarity between the packet name of the packet where the candidate code element is located and the packet name of the packet where the first code file is located can be determined based on an editing distance between the packet name of the packet where the candidate code element is located and the packet name of the packet where the first code file is located. For example, the ratio of 1 to the editing distance can be taken as a score indicating the similarity between the packet name of the packet where the candidate code element is located and the packet name of the packet where the first code file is located, and then the ratio of 1 to the editing distance can also be taken as a score indicating the correlation between the candidate code element and the first code element.

In a possible implementation, the score of the similarity between the packet name of the packet where the candidate code element is located and the packet name of the packet where the first code file is located, and a score representing the distance between the first character position and the second character position can be obtained. The first character position is the character position of the candidate code element in the first code file, and the second character position is the character position of the position to be completed in the first code file. A weighted sum of the two scores is taken as the score indicating the correlation between the candidate code element and the first code element. The weight corresponding to each score can be set as needed.

Therefore, the correlation between the candidate code element and the first code element can be determined, in a flexible way, based on at least one of the distance between the first character position and the second character position, or the similarity between the packet name of the packet where the candidate code element is located and the packet name of the packet where the first code file is located. The first character position is the character position where the candidate code element is located in the first code file, and the second character position is the character position where the location to be complemented is located in the first code file. The accuracy for determining the correlation can be improved by comprehensively determining the correlation between the candidate code element and the first code element based on the distance between the first character position and the second character position, and the similarity between the packet name of the packet where the candidate code element is located and the packet name of the packet where the first code file.

At step 207, a second code element is determined from the candidate code element based on the correlation.

The second code element belongs to at least one of the first code file or the second code file.

In a possible implementation, the candidate code elements can be ranked based on the correlations in a descending order. The first N candidate code elements are determined to be the second code elements whose correlation with the first code element meets the preset condition. N is an integer greater than or equal to 1, which may be set as desired.

In a possible implementation, the candidate code element whose correlation with the first code element exceeds a correlation threshold may be determined from candidate code elements as the second code element whose correlation with the first code element meets the preset condition.

By determining the first node where the first code element is located in the code dependency graph firstly, it is possible to only query nodes, in the code dependency graph, that the first node points directly or indirectly via the directed edge. The second code element can be determined from the candidate code elements based on whether the correlation between each of the candidate code elements represented by these nodes and the first code element meets the preset condition. Therefore, the query range of nodes in the code dependency graph can be reduced, and the efficiency for determining the second code element can thus be improved.

It is noted that through the manner shown in steps 204-207, by querying the code dependency graph based on the first code element, the second code element whose correlation with the first code element meets the preset condition can be obtained. The second code element belongs to at least one of the first code file or the second code file. In a possible implementation, by querying the code dependency graph based on the first code element, the second code element whose correlation with the first code element meets the preset condition can be obtained in other ways, in which the second code element belongs to at least one of the first code file or the second code file. For example, any node other than the first node in the code dependency graph can be taken as a candidate node, then the correlation between the candidate code element represented by the candidate node and the first code element can be determined. Based on the correlation, the second code element can be determined from the candidate code elements.

At step 208, a target code corresponding to the position to be completed is generated through a big model based on a signature of the second code element.

Specific implementations of steps 201-208 that are similar to those in other embodiments may be described in detail with reference to other embodiments of the disclosure, and will not be specifically repeated herein.

In the embodiments of the disclosure, the first code element, where the position to be completed is located, in the first code file to be completed is determined. The second code file having a dependency relationship with the first code file is determined from the development project to which the first code file belongs. The code dependency graph is constructed based on the first code file and the second code file, in which the code dependency graph includes at least two nodes and at least one directed edge between the nodes, the node represents a code element, and the directed edge represents a dependency relationship between code elements corresponding to nodes that are connected by the directed edge. The first node where the first code element is located in the code dependency graph is then determined. The candidate node is obtained by querying the code dependency graph based on the first node, in which the candidate node includes a node directly or indirectly pointed by the first node through the directed edge. The correlation between the candidate code element represented by the candidate node and the first code element is determined. The second code element is determined from the candidate code element based on the correlation. In this way, by querying the code dependency graph based on the first code element, the second code element whose correlation with the first code element meets the preset condition is obtained. The second code element belongs to at least one of the first code file or the second code file. Since the code dependency graph clearly shows the dependency relationship between code elements, and the code dependency graph can be constructed based on the first code file and the second code file. By querying the code dependency graph according to the first code element, it is possible to traverse the code elements in the first code file and the second code file based on the code dependency graph and then accurately determine the second code element whose correlation with the first code element meets the preset condition. Based on the signature of the second code element, the target code corresponding to the location to be completed is generated by the big model, which can further improve the accuracy of code completion by the big model.

The code completion method based on the big model provided by embodiments of the disclosure is further described below in combination with FIG. 4.

FIG. 4 is a flowchart of a code completion method based on a big model provided by yet another embodiment of the disclosure.

As illustrated in FIG. 4, the code completion method based on the big model includes the following steps.

At step 401, a syntax tree corresponding to the first code file is obtained.

The syntax tree is a tree representation of a code. The syntax tree breaks down the code into a series of structured nodes according to the syntax rules of language. Each node in the syntax tree represents a construction in the code, such as an expression, a statement, and a declaration.

The syntax tree corresponding to the first code file is the tree representation of the code in the first code file, which can be generated according to methods in the related art. The process of generating the syntax tree corresponding to the first code file will not be repeated herein in the disclosure.

At step 402, the first code element where the position to be completed is located in the first code file is obtained by traversing the syntax tree.

It is appreciated that each node in the syntax tree corresponding to the first code file represents a construction in the code of the first code file. The construction includes a function field of the position to be completed in the first code file. The function field of the position to be completed specifies which variables, functions, classes, etc. can be accessed by the position to be completed. By traversing the syntax tree, the function field of the position to be completed can be obtained. The first code element where the position to be completed is located in the first code file is determined according to the function field of the position to be completed.

In a possible implementation, the first code element where the position to be completed is located in the first code file may include classes that can be accessed by the position to be completed in the first code file.

Since the syntax tree clearly shows constructions in the code, the first code element where the position to be completed is located in the first code file can be quickly and accurately determined by traversing the syntax tree corresponding to the first code file.

At step 403, a second code file having a dependency relationship with the first code file is determined from a development project to which the first code file belongs.

In a possible implementation, step 403 may be implemented by:
obtaining a candidate code file in the development project to which the first code file belongs; and
performing syntax analysis on the candidate code file to obtain the second code file having a dependency relationship with the first code file in the candidate code file.

The candidate code file may be any code file other than the first code file under the development project to which the first code file belongs. There may be one candidate code file or at least two candidate code files.

For each candidate code file, by performing syntax analysis on the candidate code file, it can be determined whether the first code file needs the resources provided by the candidate code file to work normally, or whether the candidate code file needs the resources provided by the first code file to work normally, and then it is further determined whether there is a dependency relationship between the candidate code file and the first code file.

By performing syntax analysis on the candidate code file under the development project to which the first code file belongs, the second code file having a dependency relationship with the first code file, in the development project to which the first code file belongs, can be accurately obtained.

In a possible implementation, for each code file, the code completion device based on the big model can regularly perform syntax analysis on other code files under the development project to which the first code file belongs in the background, to obtain a code file having a dependency relationship with the code file. When the first code file is accessed, the second code file having a dependency relationship with the first code file under the development project to which the first code file belongs can be obtained directly from the files obtained in advance. When code completion of the first code file is required, the second code file having a dependency relationship with the first code file can be quickly obtained under the development project to which the first code file belongs.

It is understood that in the abovementioned way of obtaining files at regular intervals in the background, it is possible that when the first code file is accessed, syntax analysis has not yet been finished for other code files under the development project to which the first code file belongs in the background. In a possible implementation, the code completion device based on the big model may, when the first code file is accessed, obtain the second code file having a dependency relationship with the first code file by performing syntax analysis for other candidate code files under the development project to which the first code file belongs in real time. Therefore, when it is needed to perform the code completion on the first code file, the second code file having a dependency relationship with the first code file under the development project to which the first code file belongs can be obtained more comprehensively.

In a possible implementation, it is also possible to combine the above two ways to comprehensively and quickly obtain the second code file having a dependency relationship with the first code file under the development project to which the first code file belongs.

At step 404, according to the first code element, a second code element whose correlation with the first code element meets a preset condition is determined, in which the second code element belongs to at least one of the first code file or the second code file.

At step 405, a context code of the position to be completed in the first code file is obtained.

The context code of the position to be completed may include at least one of a code before the position to be completed or a code after the position to be completed in the first code file.

At step 406, the signature of the second code element and the context code are input into the big model, and the target code output by the big model is obtained.

In a possible implementation, in a case where the second code element includes one code element, the signature of the code element and the context code of the position to be completed can be input into the big model, and the big model can output the target code corresponding to the position to be completed.

In a possible implementation, in a case where the second code element includes at least two code elements, the respective signatures of the at least two code elements and the context code of the position to be completed can be input into the big model, and the big model outputs the target code corresponding to the position to be completed.

Therefore, when generating the target code corresponding to the position to be completed through the big model, the big model not only considers the code elements, whose correlation with the first code element meets the preset condition, in the first code file to be completed and the second code file having a dependency relationship with the first code file, but also considers the context code of the position to be completed in the first code file. Therefore, the target code corresponding to the position to be completed can be generated based on more comprehensive information, which can further improve the accuracy of code completion through the big model.

It is understood that the length of character input to the big model is limited, and the longer the length, the slower the reasoning speed of the big model. In a possible implementation of the disclosure, in the case where the second code element includes at least two code elements in the same code file, the signatures of the at least two code elements can be combined to obtain a combined signature. The combined signature and the context code of the position to be completed are input into the big model, and the big model outputs the target code corresponding to the position to be completed.

That is, in a case where the second code element includes at least two code elements in the same code file, step 406 may be replaced by the following steps, including:
obtaining a combined signature by combining the signatures of the at least two code elements; and
inputting the combined signature and the context code into the big model and obtaining the target code output by the big model.

The way of combining the respective signatures of the at least two code elements to obtain the combined signature can be set as desired. For example, a common portion of the signatures of the at least two code elements may be extracted, and the common portion may then be referenced in the description to obtain the combined signature. Alternatively, meaningful abbreviations may be used for the respective signatures of the at least two code elements, and then the abbreviations may be spliced together to obtain the combined signature.

In a case where the second code element includes at least two code elements in the same code file, by combining the respective signatures of the at least two code elements, a combined signature is obtained. The combined signature and the context code are input into the big model, which can reduce the length of character input into the big model, thereby saving the time for the big model to reason to obtain the target code corresponding to the position to be completed, and improving the efficiency of generating the target code corresponding to the position to be completed.

In the embodiments of the disclosure, the syntax tree corresponding to the first code file to be completed is obtained. The first code element where the position to be completed is located in the first code file is obtained by traversing the syntax tree, which can quickly and accurately determine the first code element where the position to be completed is located in the first code file. The second code file having a dependency relationship with the first code file is determined from the development project to which the first code file belongs, and based on the first code element, the second code element whose correlation with the first code element meets the preset condition is determined. The second code element belongs to at least one of the first code file or the second code file. The context code of the position to be completed in the first code file is obtained, and the signature of the second code element and the context code are input into the big model, and the big model outputs the target code corresponding to the position to be completed. The big model not only considers the code elements whose correlation with the first code element meets the preset condition in the first code file to be completed and the second code file having a dependency relationship with the first code file, but also considers the context code of the position to be completed in the first code file. Therefore, the target code corresponding to the position to be completed can be generated based on more comprehensive information, which can further improve the accuracy of code completion through the big model.

In order to realize the above embodiments, the disclosure also provides a code completion device based on a big model.

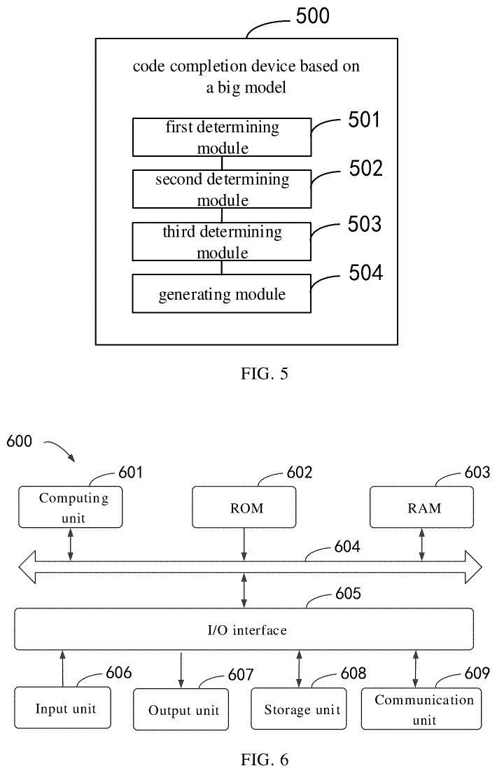

FIG. 5 is a schematic diagram of a code completion device 500 based on a big model provided by an embodiment of the disclosure.

As illustrated in FIG. 5, the code completion device 500 based on the big model includes:
a first determining module 501, configured to determine a first code element, where a position to be completed is located, in a first code file to be completed;
a second determining module 502, configured to determine a second code file having a dependency relationship with the first code file from a development project to which the first code file belongs;
a third determining module 503, configured to determine, according to the first code element, a second code element whose correlation with the first code element meets a preset condition, in which the second code element belongs to at least one of the first code file or the second code file; and
a generating module 504, configured to generate a target code corresponding to the position to be completed through a big model based on a signature of the second code element.

As a possible implementation of embodiments of the disclosure, the third determining module 503 includes:
a constructing sub-module, configured to construct a code dependency graph based on the first code file and the second code file, in which the code dependency graph comprises at least two nodes and at least one directed edge between the nodes, the node represents a code element, and the directed edge represents a dependency relationship between code elements corresponding to nodes that are connected by the directed edge; and
a querying sub-module, configured to query the code dependency graph according to the first code element to obtain the second code element.

As a possible implementation of embodiments of the disclosure, the querying sub-module includes:
a first determining unit, configured to determine a first node where the first code element is located in the code dependency graph;
a querying unit, configured to query the code dependency graph based on the first node to obtain a candidate node, in which the candidate node includes a node directly or indirectly pointed by the first node through the directed edge;
a second determining unit, configured to determine a correlation between a candidate code element represented by the candidate node and the first code element; and
a third determining unit, configured to determine the second code element from the candidate code element based on the correlation.

As a possible implementation of embodiments of the disclosure, the dependency relationship represented by the directed edge in the code dependency graph includes at least one of: an extend relationship or an implements relationship, and the candidate node includes at least one of a second node or a third node;
in which the second node is located on a target path where the first node is located and is directly or indirectly pointed by the first node through the directed edge, and the dependency relationship represented by the directed edge on the target path is either the extend relationship or the implements relationship; and
the third node is a node directly pointed by the first node or the second node through the directed edge, and the dependency relationship represented by the directed edge between the first node or the second node and the third node is a dependency relationship other than the extend relationship and the implements relationship.

As a possible implementation of embodiments of the disclosure, the second determining unit includes:
a determining sub-unit, configured to determine the correlation between the candidate code element and the first code element based on at least one of:
a similarity between a packet name of a packet where the candidate code element is located and a packet name of a packet where the first code file is located; or
a distance between a first character position of the candidate code element in the first code file and a second character position of the position to be completed in the first code file;
in which in a case where the candidate code element is not in the first code file, the first character position is determined based on a character position of the first code element in the first code file.

As a possible implementation of embodiments of the disclosure, the code element includes at least one of: a class, an interface, a field, a class method, an inner class or a configuration file, and the dependency relationship between the code elements includes at least one of:
an extend relationship between the classes;
an implements relationship between the class and the interface;
an include relationship between the class and the field;
an include relationship between the class and the class method;
an include relationship between the class and the inner class;
a configure relationship between the class and the configuration file;
a parmer_in relationship between the class and the class method; or
a parmer_out relationship between the class and the class method.

As a possible implementation of embodiments of the disclosure, the first determining module 501 includes:
a first obtaining sub-module, configured to obtain a syntax tree corresponding to the first code file; and
a second obtaining sub-module, configured to obtain the first code element where the position to be completed is located in the first code file by traversing the syntax tree.

As a possible implementation of embodiments of the disclosure, the code completion device 500 based on the big model also includes:
an obtaining module, configured to obtain a context code of the position to be completed in the first code file;
correspondingly, in which the generating module 504 includes:
a first generating sub-module, configured to input the signature of the second code element and the context code into the big model and obtain the target code output by the big model.

As a possible implementation of embodiments of the disclosure, the second code element includes at least two code elements in the same code file, and the generating module 504 includes:
a second generating sub-module, configured to obtain a combined signature by combining the signatures of the at least two code elements; and
a third generating sub-module, configured to input the combined signature and the context code into the big model and obtain the target code output by the big model.

As a possible implementation of embodiments of the disclosure, the second determining module 502 includes:
a third obtaining sub-module, configured to obtain a candidate code file in the development project to which the first code file belongs; and
an analysis sub-module, configured to perform syntax analysis on the candidate code file to obtain the second code file having the dependency relationship with the first code file in the candidate code file.

It should be noted that the above explanation of the code completion method based on the big model is also applicable to the code completion device based on the big model in this embodiment, and will not be repeated here.

According to embodiments of the disclosure, the disclosure also provides an electronic device, a readable storage medium, and a computer program product.

FIG. 6 is a schematic diagram of an exemplary electronic device 600 used to implement the embodiments of the disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile devices, such as personal digital processors, cellular phones, smart phones, wearable devices, and other similar computing devices. The components shown here, their connections and relations, and their functions are merely examples, and are not intended to limit the implementation of the disclosure described and/or required herein.

As illustrated in FIG. 6, the device 600 includes a computing unit 601 for performing various appropriate actions and processes based on computer programs stored in a Read-Only Memory (ROM) 602 or computer programs loaded from a storage unit 608 to a Random Access Memory (RAM) 603. In the RAM 603, various programs and data required for the operation of the device 600 are stored. The computing unit 601, the ROM 602, and the RAM 603 are connected to each other through a bus 604. An input/output (I/O) interface 605 is also connected to the bus 604.

Components in the device 600 are connected to the I/O interface 605, including: an input unit 606, such as a keyboard, a mouse; an output unit 607, such as various types of displays, speakers; a storage unit 608, such as a disk, an optical disk; and a communication unit 609, such as network cards, modems, and wireless communication transceivers. The communication unit 609 allows the device 600 to exchange information/data with other devices through a computer network such as the Internet and/or various telecommunication networks.

The computing unit 601 may be various general-purpose and/or dedicated processing components with processing and computing capabilities. Some examples of the computing unit 601 include, but are not limited to, a Central Processing Unit (CPU), a Graphics Processing Unit (GPU), various dedicated AI computing chips, various computing units that run machine learning (ML) model algorithms, a Digital Signal Processor (DSP), and any appropriate processor, controller and microcontroller. The computing unit 601 executes the various methods and processes described above, such as the code completion method based on the big model. For example, in some embodiments, the code completion method based on the big model may be implemented as a computer software program, which is tangibly contained in a machine-readable medium, such as the storage unit 608. In some embodiments, part or all of the computer programs may be loaded and/or installed on the device 600 via the ROM 602 and/or the communication unit 609. When the computer program is loaded on the RAM 603 and executed by the computing unit 601, one or more steps of the code completion method based on the big model described above may be executed. Alternatively, in other embodiments, the computing unit 601 may be configured to perform the code completion method based on the big model in any other suitable manner (for example, by means of firmware).

Various implementations of the systems and techniques described above may be implemented by a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, a firmware, a software, and/or a combination thereof. These various implementations may be implemented in one or more computer programs, the one or more computer programs may be executed and/or interpreted on a programmable system including at least one programmable processor, which may be a dedicated or general programmable processor for receiving data and instructions from a storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage medium include electrical connections based on one or more wires, portable computer disks, hard disks, RAMs, ROMs, Electrically Programmable Read-Only-Memories (EPROM), flash memories, fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: Local Area Network (LAN), Wide Area Network (WAN), the Internet and a block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host. The server is a host product in a cloud computing service system to solve difficult management and poor business expansion of traditional physical hosting and Virtual Private Server (VPS) services. The server may be a server of a distributed system, or a server combined with a block-chain.

It is noted that AI is a subject that causes computers to simulate certain thinking processes and intelligent behaviors (such as learning, reasoning, thinking and planning) of human beings, which covers both hardware-level technologies and software-level technologies. The AI hardware technologies generally include technologies such as sensors, dedicated AI chips, cloud computing, distributed storage, and big data processing. The AI software technologies generally include several major aspects such as computer vision technology, speech recognition technology, natural language processing technology, learning/deep learning, big data processing technology and knowledge graph technology.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific implementations do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. A code completion method based on a big model, comprising:
determining a first code element, where a position to be completed is located, in a first code file to be completed;
determining a second code file having a dependency relationship with the first code file from a development project to which the first code file belongs;
determining, according to the first code element, a second code element whose correlation with the first code element meets a preset condition, wherein the second code element belongs to at least one of the first code file or the second code file; and
generating a target code corresponding to the position to be completed through a big model based on a signature of the second code element.

2. The method of claim 1, wherein determining, according to the first code element, the second code element whose correlation with the first code element meets the preset condition, comprises:
constructing a code dependency graph based on the first code file and the second code file, wherein the code dependency graph comprises at least two nodes and at least one directed edge between the nodes, the node represents a code element, and the directed edge represents a dependency relationship between code elements corresponding to nodes that are connected by the directed edge; and
obtaining the second code element by querying the code dependency graph according to the first code element.

3. The method of claim 2, wherein obtaining the second code element by querying the code dependency graph according to the first code element, comprises:
determining a first node, where the first code element is located, in the code dependency graph;
obtaining a candidate node by querying the code dependency graph based on the first node, wherein the candidate node comprises a node directly or indirectly pointed by the first node through the directed edge;
determining a correlation between a candidate code element represented by the candidate node and the first code element; and
determining the second code element from the candidate code element based on the correlation.

4. The method of claim 3, wherein the dependency relationship represented by the directed edge in the code dependency graph comprises at least one of: an extend relationship, or an implements relationship, and the candidate node comprises at least one of a second node or a third node;
wherein the second node is located on a target path where the first node is located and is directly or indirectly pointed by the first node through the directed edge, and the dependency relationship represented by the directed edge on the target path is either the extend relationship or the implements relationship; and
the third node is a node directly pointed by the first node or the second node through the directed edge, and the dependency relationship represented by the directed edge between the first node or the second node and the third node is a dependency relationship other than the extend relationship and the implements relationship.

5. The method of claim 3, wherein determining the correlation between the candidate code element represented by the candidate node and the first code element, comprises:
determining the correlation between the candidate code element and the first code element based on at least one of:
a similarity between a packet name of a packet where the candidate code element is located and a packet name of a packet where the first code file is located; or
a distance between a first character position of the candidate code element in the first code file and a second character position of the position to be completed in the first code file;
wherein in a case where the candidate code element is not in the first code file, the first character position is determined based on a character position of the first code element in the first code file.

6. The method of claim 2, wherein the code element comprises at least one of: a class, an interface, a field, a class method, an inner class or a configuration file, and the dependency relationship between the code elements comprises at least one of:
an extend relationship between the classes;
an implements relationship between the class and the interface;
an include relationship between the class and the field;
an include relationship between the class and the class method;
an include relationship between the class and the inner class;
a configure relationship between the class and the configuration file;
a parmer_in relationship between the class and the class method; or
a parmer_out relationship between the class and c the lass method.

7. The method of claim 1, wherein determining the first code element, where the position to be completed is located, in the first code file to be completed, comprises:
obtaining a syntax tree corresponding to the first code file; and
obtaining the first code element where the position to be completed is located in the first code file by traversing the syntax tree.

8. The method of claim 1, wherein before generating the target code corresponding to the position to be completed through the big model based on the signature of the second code element, the method further comprises:
obtaining a context code of the position to be completed in the first code file;
wherein generating the target code corresponding to the position to be completed through the big model based on the signature of the second code element, comprises:
inputting the signature of the second code element and the context code into the big model and obtaining the target code output by the big model.

9. The method of claim 8, wherein the second code element comprises at least two code elements in the same code file;
wherein generating the target code corresponding to the position to be completed through the big model based on the signature of the second code element, comprises:
obtaining a combined signature by combining the signatures of the at least two code elements; and
inputting the combined signature and the context code into the big model and obtaining the target code output by the big model.

10. The method of claim 1, wherein determining the second code file having a dependency relationship with the first code file from the development project to which the first code file belongs, comprises:
obtaining a candidate code file in the development project to which the first code file belongs; and
performing syntax analysis on the candidate code file to obtain the second code file having the dependency relationship with the first code file in the candidate code file.

11. An electronic device, comprising:
at least one processor; and
a memory communicatively connected to the at least one processor;
wherein the memory stores instructions executable by the at least one processor, and the instructions are executed by the at least one processor to cause the at least one processor to perform operations comprising:
determining a first code element, where a position to be completed is located, in a first code file to be completed;
determining a second code file having a dependency relationship with the first code file from a development project to which the first code file belongs;
determining, according to the first code element, a second code element whose correlation with the first code element meets a preset condition, wherein the second code element belongs to at least one of the first code file or the second code file; and
generating a target code corresponding to the position to be completed through a big model based on a signature of the second code element.

12. The electronic device of claim 11, wherein determining, according to the first code element, the second code element whose correlation with the first code element meets the preset condition, comprises:
constructing a code dependency graph based on the first code file and the second code file, wherein the code dependency graph comprises at least two nodes and at least one directed edge between the nodes, the node represents a code element, and the directed edge represents a dependency relationship between code elements corresponding to nodes that are connected by the directed edge; and
obtaining the second code element by querying the code dependency graph according to the first code element.

13. The electronic device of claim 12, wherein obtaining the second code element by querying the code dependency graph according to the first code element, comprises:
determining a first node, where the first code element is located, in the code dependency graph;
obtaining a candidate node by querying the code dependency graph based on the first node, wherein the candidate node comprises a node directly or indirectly pointed by the first node through the directed edge;
determining a correlation between a candidate code element represented by the candidate node and the first code element; and
determining the second code element from the candidate code element based on the correlation.

14. The electronic device of claim 13, wherein the dependency relationship represented by the directed edge in the code dependency graph comprises at least one of: an extend relationship, or an implements relationship, and the candidate node comprises at least one of a second node or a third node;
wherein the second node is located on a target path where the first node is located and is directly or indirectly pointed by the first node through the directed edge, and the dependency relationship represented by the directed edge on the target path is either the extend relationship or the implements relationship; and
the third node is a node directly pointed by the first node or the second node through the directed edge, and the dependency relationship represented by the directed edge between the first node or the second node and the third node is a dependency relationship other than the extend relationship and the implements relationship.

15. The electronic device of claim 13, wherein determining the correlation between the candidate code element represented by the candidate node and the first code element, comprises:
determining the correlation between the candidate code element and the first code element based on at least one of:
a similarity between a packet name of a packet where the candidate code element is located and a packet name of a packet where the first code file is located; or
a distance between a first character position of the candidate code element in the first code file and a second character position of the position to be completed in the first code file;
wherein in a case where the candidate code element is not in the first code file, the first character position is determined based on a character position of the first code element in the first code file.

16. The electronic device of claim 12, wherein the code element comprises at least one of: a class, an interface, a field, a class method, an inner class or a configuration file, and the dependency relationship between the code elements comprises at least one of:
an extend relationship between the classes;
an implements relationship between the class and the interface;
an include relationship between the class and the field;
an include relationship between the class and the class method;
an include relationship between the class and the inner class;
a configure relationship between the class and the configuration file;
a parmer_in relationship between the class and the class method; or
a parmer_out relationship between the class and c the lass method.

17. The electronic device of claim 11, wherein determining the first code element, where the position to be completed is located, in the first code file to be completed, comprises:
obtaining a syntax tree corresponding to the first code file; and
obtaining the first code element where the position to be completed is located in the first code file by traversing the syntax tree.

18. The electronic device of claim 11, wherein before generating the target code corresponding to the position to be completed through the big model based on the signature of the second code element, the at least one processor further performs:
obtaining a context code of the position to be completed in the first code file;
wherein generating the target code corresponding to the position to be completed through the big model based on the signature of the second code element, comprises:
inputting the signature of the second code element and the context code into the big model and obtaining the target code output by the big model.

19. The electronic device of claim 18, wherein the second code element comprises at least two code elements in the same code file;
wherein generating the target code corresponding to the position to be completed through the big model based on the signature of the second code element, comprises:
obtaining a combined signature by combining the signatures of the at least two code elements; and
inputting the combined signature and the context code into the big model and obtaining the target code output by the big model.

20. A non-transitory computer-readable storage medium having computer instructions stored thereon, wherein the computer instructions are used to cause the computer to perform operations comprising:
determining a first code element, where a position to be completed is located, in a first code file to be completed;
determining a second code file having a dependency relationship with the first code file from a development project to which the first code file belongs;
determining, according to the first code element, a second code element whose correlation with the first code element meets a preset condition, wherein the second code element belongs to at least one of the first code file or the second code file; and
generating a target code corresponding to the position to be completed through a big model based on a signature of the second code element.
